(19) United States
(12) Patent Application Publication
(10) Pub. No.: US 2013/0118369 A1
(43) Pub. Date: May 16, 2013

(54) PRINT SYSTEM WITH RIBBON IDENTIFICATION FUNCTION

(71) Applicant: Kai-Min Chu, Taipei City (TW)

(72) Inventor: Kai-Min Chu, Taipei City (TW)

(21) Appl. No.: 13/400,590

(22) Filed: Feb. 21, 2012

(30) Foreign Application Priority Data
Nov. 15, 2011 (TW) 100141604

(51) Int. Cl. B41F 31/00

(52) U.S. Cl. 101/244

(57) ABSTRACT

A print system includes a supporting base, and a ribbon shaft rotatably installed inside the supporting base for carrying a ribbon. The print system further includes a chip card connected to the ribbon shaft for storing information of the ribbon, and a card reader installed on a side of the supporting base for reading the information stored in the chip card as the ribbon shaft is installed inside the supporting base.

### BACKGROUND OF THE INVENTION

1. Field of the Invention

The present invention relates to a print system with ribbon identification function, and more specifically, to a print system capable of identifying information of a ribbon with a chip card connected to a ribbon shaft.

2. Description of the Prior Art

Due to the full tone printing performance, a dye sublimation printer becomes a trend in the printing market. The ribbon identification is often achieved by chip control, for reading ribbon information of a type, an area code, remaining ribbons, and so on. The conventional mechanical design is to separate a chip card from a ribbon shaft, and a user has to separately install the chip card and the ribbon shaft for printing. It might cause problems of missing the chip card, installing the wrong chip card so that the ribbon and the chip card can not match, and so on. Therefore, there is a need to provide ribbon identification mechanism with easy assembly and capable of preventing assembly errors in the print industry.

### SUMMARY OF THE INVENTION

The present invention provides a print system capable of identifying information of a ribbon with a chip card connected to a ribbon shaft to solve the problems mentioned above.

According to the claimed invention, a print system includes a supporting base, and a ribbon shaft rotatably installed inside the supporting base for carrying a ribbon. The print system further includes a chip card connected to the ribbon shaft for storing information of the ribbon, and a card reader installed on a side of the supporting base for reading the information stored in the chip card as the ribbon shaft is installed inside the supporting base.

According to the claimed invention, a slot is formed on an end of the ribbon shaft and the chip card is wedged inside the slot on the ribbon shaft.

According to the claimed invention, the ribbon shaft is capable of pivoting relative to the chip card as the chip card is wedged inside the slot on the ribbon shaft.

According to the claimed invention, the chip card includes a base for connecting with the ribbon shaft, a chip installed on the base, and at least one foolproof rib disposed on the base along an assembly direction.

According to the claimed invention, the assembly direction is substantially perpendicular to an axial direction of the ribbon shaft.

According to the claimed invention, the print system is a dye sublimation print system.

The print system of the present invention combines the chip card with the ribbon shaft, so that the chip card and the ribbon shaft can be installed inside a machine together as utilizing the ribbon. It can solve problems of missing the chip card and installing the wrong chip card so that the ribbon and the chip card can not match in the prior art. Therefore, the present invention provides the ribbon identification mechanism with easy assembly and capable of preventing assembly errors in the print industry.

These and other objectives of the present invention will no doubt become obvious to those of ordinary skill in the art after reading the following detailed description of the embodiment that is illustrated in the various figures and drawings.

### BRIEF DESCRIPTION OF THE DRAWINGS

FIG. 1 is a diagram of a print system according to a preferred embodiment of the present invention.

FIG. 2 is a diagram of a ribbon shaft having not been installed inside a supporting base according to the preferred embodiment of the present invention.

FIG. 3 is a diagram of the ribbon shaft being installed inside the supporting base according to the preferred embodiment of the present invention.

FIG. 4 is a diagram of a chip card combined with the ribbon shaft according to the preferred embodiment of the present invention.

FIG. 5 and FIG. 6 are diagrams of the chip card being assembled incorrectly at different views according to the preferred embodiment of the present invention.

### DETAILED DESCRIPTION

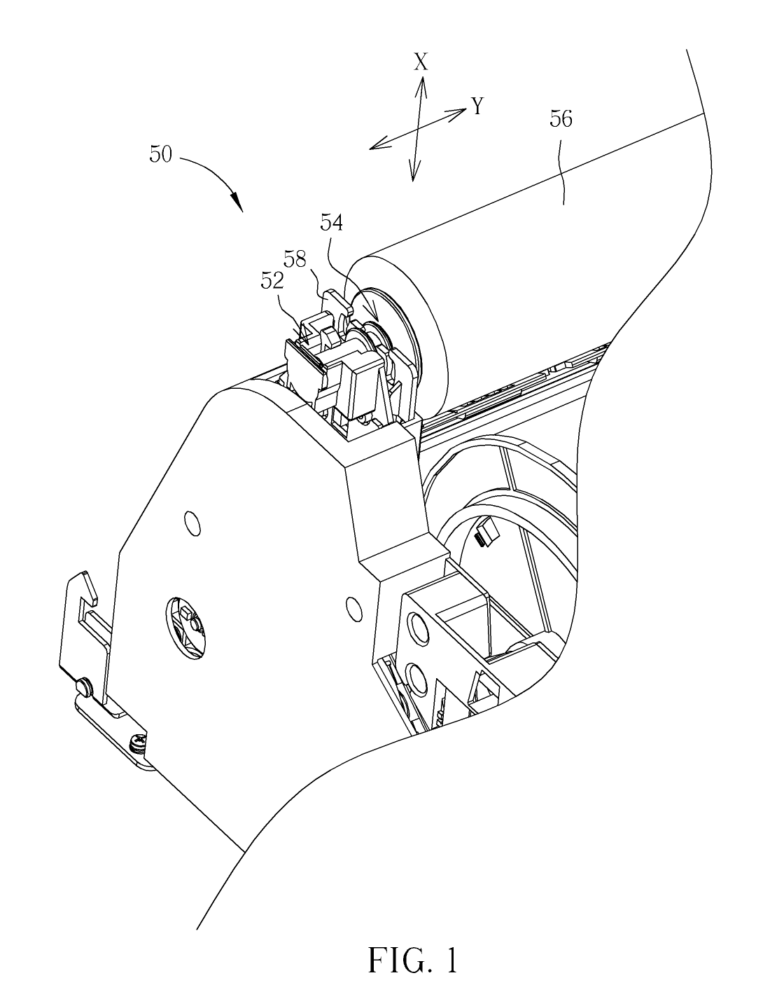

Please refer to FIG. 1. FIG. 1 is a diagram of a print system 50 according to a preferred embodiment of the present invention. The print system 50 can be a dye sublimation print system. The print system 50 includes a supporting base 52 and a ribbon shaft 54 rotatably installed inside the supporting base 52 for carrying a ribbon 56. The print system further includes a chip card 58 connected to the ribbon shaft 54, such as being wedged with the ribbon shaft 54. The structural design for combining the chip card 58 and the ribbon shaft 54 is within the scope of the present invention. The chip card 58 is for storing information of the ribbon 56, such as a type, an area code, remaining ribbons, and so on.

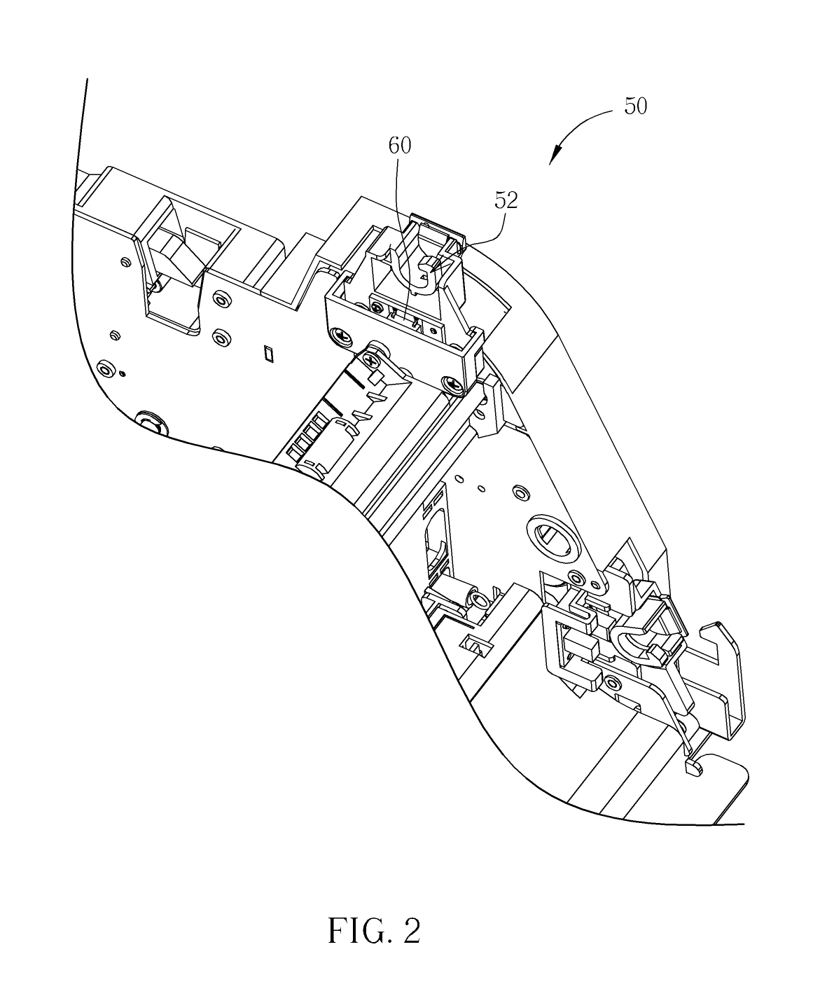

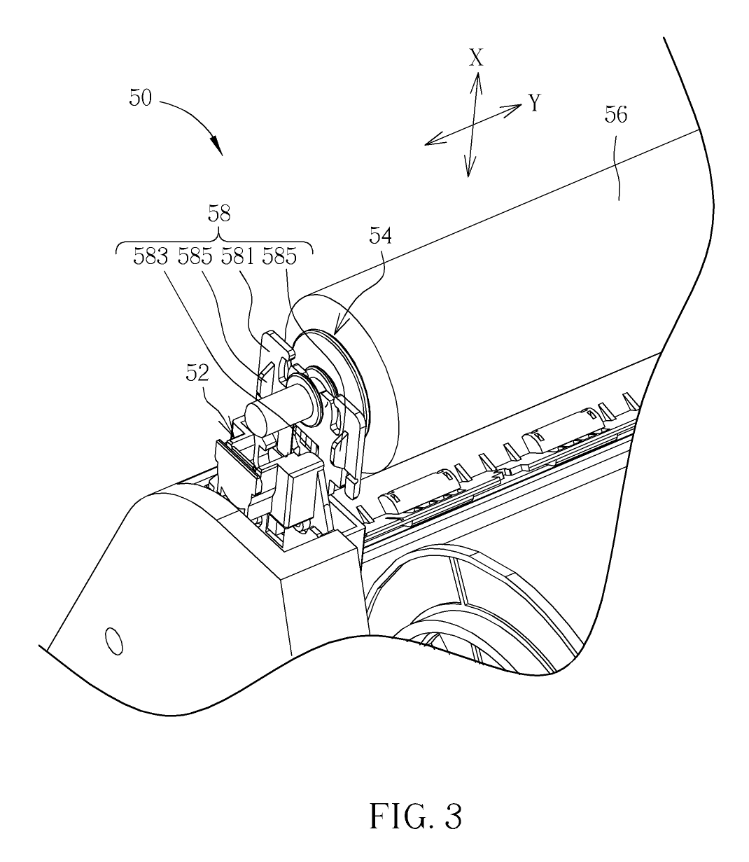

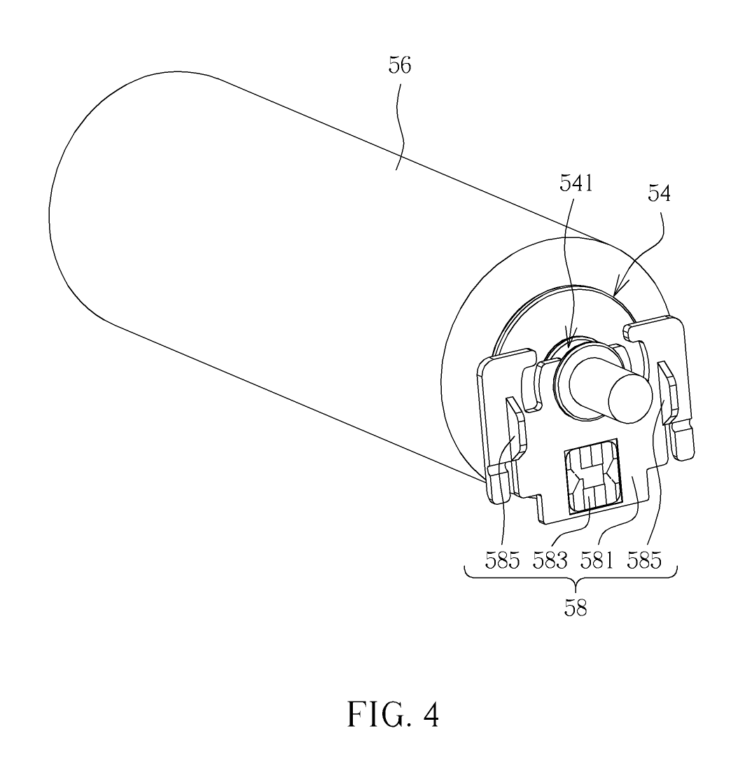

Please refer to FIG. 2 to FIG. 4. FIG. 2 is a diagram of the ribbon shaft 54 having not been installed inside the supporting base 52 according to the preferred embodiment of the present invention. FIG. 3 is a diagram of the ribbon shaft 54 being installed inside the supporting base 52 according to the preferred embodiment of the present invention. FIG. 4 is a diagram of the chip card 58 combined with the ribbon shaft 54 according to the preferred embodiment of the present invention. The print system further includes a card reader 60 installed on a side of the supporting base 52 for reading the information stored in the chip card 58 as the ribbon shaft 54 is installed inside the supporting base 52. The chip card 58 includes a base 581 for connecting with the ribbon shaft 54. For example, a slot 541 is formed on an end of the ribbon shaft 54, and the base 581 of the chip card 58 can be wedged inside the slot 541 on the ribbon shaft 54. The ribbon shaft 54 is capable of pivoting relative to the chip card 58 as the chip card 58 is wedged inside the slot 541 on the ribbon shaft 54, so that the ribbon 56 can be conveyed to a printing area. The chip card 58 further includes a chip 583 installed on the base 581, and the chip 583 is for storing the information of the ribbon 56, such as the type, the area code, remaining ribbons, and so on. When the ribbon shaft 54 is installed inside the supporting base 52, the card reader 60 is located in a position corresponding to the chip 583 of the chip card 58 so as to read data stored in the chip 583.

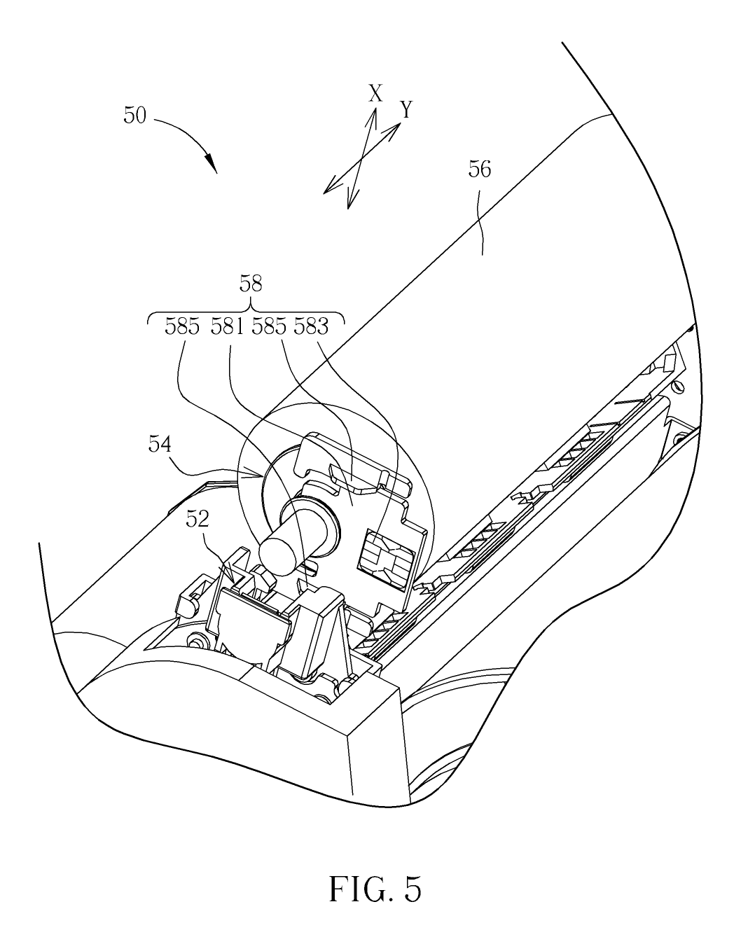

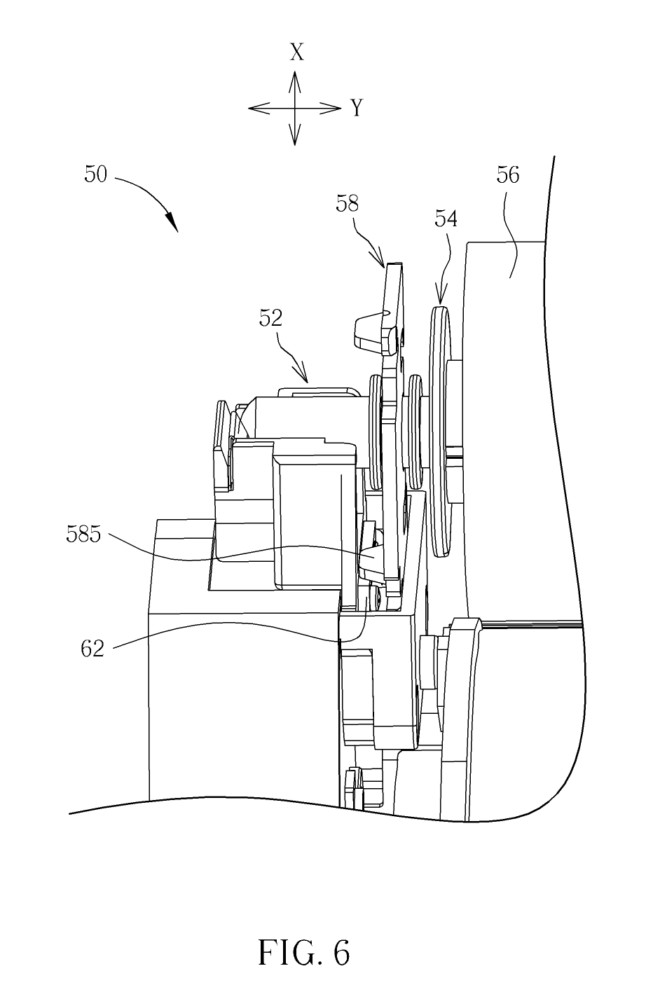

Furthermore, the chip card 58 further includes at least one foolproof rib 585 disposed on the base 581 along an assembly direction (X direction), and the assembly direction can be substantially perpendicular to an axial direction (Y direction) of the ribbon shaft 54. In this embodiment, there are two foolproof rib 585 disposed on two sides of the base 581. An amount and disposal of the foolproof rib 585 are not limited to those mentioned above, and it depends on actual design demand. The chip card 58 connected to the ribbon shaft 54 can be correctly installed inside the supporting base 52 by the foolproof ribs 585. That is, the foolproof ribs 585 of the chip card 58 can be correctly installed inside the supporting base 52 only as being assembled in the assembly direction (X direction), and the foolproof ribs 585 of the chip card 58 can not be correctly installed inside the supporting base 52 as being assembled in a direction different from the assembly direction (X direction). Please refer to FIG. 5 and FIG. 6. FIG. 5 and FIG. 6 are diagrams of the chip card 58 being assembled incorrectly at different views according to the preferred embodiment of the present invention. For example, when the base 581 of the chip card 58 turns 90 degrees from the assembly direction to be installed inside the supporting base 52, the foolproof ribs 585 will interfere with a blocking structure 62, such as a printed circuit board, and can not be assembled downward, so as to prevent assembly errors of the ribbon shaft 54 and the chip card 58. The foolproof rib 585 of the chip card 58 can be disposed selectively, and it depends on actual design demand.

In contrast to the prior art, the print system of the present invention combines the chip card with the ribbon shaft, so that the chip card and the ribbon shaft can be installed inside a machine together as utilizing the ribbon. It can solve problems of missing the chip card and installing the wrong chip card so that the ribbon and the chip card can not match in the prior art. Therefore, the present invention provides the ribbon identification mechanism with easy assembly and capable of preventing assembly errors in the print industry.

Those skilled in the art will readily observe that numerous modifications and alterations of the device and method may be made while retaining the teachings of the invention.

What is claimed is:

1. A print system, comprising:
a supporting base;
a ribbon shaft rotatably installed inside the supporting base for carrying a ribbon;
a chip card connected to the ribbon shaft for storing information of the ribbon; and
a card reader installed on a side of the supporting base for reading the information stored in the chip card as the ribbon shaft is installed inside the supporting base.

2. The print system of claim 1, wherein a slot is formed on an end of the ribbon shaft and the chip card is wedged inside the slot on the ribbon shaft.

3. The print system of claim 2, wherein the ribbon shaft is capable of pivoting relative to the chip card as the chip card is wedged inside the slot on the ribbon shaft.

4. The print system of claim 3, wherein the chip card comprises:
a base for connecting with the ribbon shaft;
a chip installed on the base; and
at least one foolproof rib disposed on the base along an assembly direction.

5. The print system of claim 4, wherein the assembly direction is substantially perpendicular to an axial direction of the ribbon shaft.

6. The print system of claim 2, wherein the chip card comprises:
a base for connecting with the ribbon shaft;
a chip installed on the base; and
at least one foolproof rib disposed on the base along an assembly direction.

7. The print system of claim 6, wherein the assembly direction is substantially perpendicular to an axial direction of the ribbon shaft.

8. The print system of claim 1, wherein the chip card comprises:
a base for connecting with the ribbon shaft;
a chip installed on the base; and
at least one foolproof rib disposed on the base along an assembly direction.

9. The print system of claim 8, wherein the assembly direction is substantially perpendicular to an axial direction of the ribbon shaft.

10. The print system of claim 1, being a dye sublimation print system.
